(19) United States
(12) Patent Application Publication
(10) Pub. No.: US 2024/0191932 A1
(43) Pub. Date: Jun. 13, 2024

(54) ALUMINUM EXTERIOR PANEL AND METHOD FOR MANUFACTURING SAME

(71) Applicant: SAMSUNG ELECTRONICS CO., LTD., Suwon-si (KR)

(72) Inventors: Kyunghwan LEE, Suwon-si (KR); Youngdeog KOH, Suwon-si (KR); Jihwan CHUN, Suwon-si (KR); Heecheol KANG, Suwon-si (KR); Kwangjoo KIM, Suwon-si (KR); Jinju KIM, Suwon-si (KR); Minkyung LEE, Suwon-si (KR)

(73) Assignee: SAMSUNG ELECTRONICS CO., LTD., Suwon-si (KR)

(21) Appl. No.: 18/583,013

(22) Filed: Feb. 21, 2024

Related U.S. Application Data
(63) Continuation of application No. PCT/KR2022/018195, filed on Nov. 17, 2022.

(30) Foreign Application Priority Data
Jan. 11, 2022 (KR) 10-2022-0004275

(51) Int. Cl. F25D 23/00; B23K 26/359; B41M 5/00; C23F 1/36; C25D 11/04

(52) U.S. Cl. CPC F25D 23/00; B41M 5/0058; C23F 1/36; C25D 11/04; B23K 26/359; F25D 2323/06

(57) ABSTRACT

A manufacturing method of an aluminum exterior panel including preparing an aluminum material; machining to shape an edge of the aluminum material; implementing a fine multilayered pattern on a surface of the processed aluminum material; forming of forming fine corrugations on the surface of the aluminum material on which the fine multilayered pattern is implemented; anodizing to form pores on the surface of the aluminum material on which the fine corrugations are formed; digital printing of implementing a color and an image on the aluminum material on which the pores are formed; and sealing to close the pores.

### CROSS-REFERENCE TO RELATED APPLICATION

This application is a continuation application, under 35 U.S.C. § 111(a), of international application No. PCT/KR2022/018195, filed on Nov. 17, 2022, which claims priority under 35 U. S. C. § 119 to Korean Patent Application No. 10-2022-0004275, filed Jan. 11, 2022, the disclosures of which are incorporated herein by reference in their entireties.

### BACKGROUND

### Field

The present invention relates to an aluminum exterior panel and a manufacturing method thereof, and more particularly, to an aluminum exterior panel with an improved stereoscopic effect, color stability, and durability and a manufacturing method thereof.

### Description of the Related Art

In recent years, exterior panels applied to home appliances such as a refrigerator, a washing machine, a dish washer, an oven, and a hood are manufactured to implement an image or a pattern on a surface thereof to give an aesthetic effect.

In implementing an image or a pattern on an aluminum surface, printing methods such as silk printing after anodizing, gravure printing, polyethylene terephthalate (PET) printing, and ultraviolet (UV) inkjet printing and a method in which portions having negative angles are formed through rolling and then finished with anodizing have been introduced.

However, in color implementation using a typical anodizing technique, a color difference may occur between different production lots according to anodizing electrolysis conditions, and thus color stability is reduced.

Also, when an image or a pattern is printed on a typical aluminum surface or an anodized aluminum surface, there is a problem in that a print layer with weak hardness is formed at the outermost layer and may be damaged or separated due to external impact.

In addition, since an amorphous, nonreactive oxide film (Al₂O₃) is formed on the aluminum surface or anodized aluminum surface, and adhesion to the print layer is significantly reduced, there is also a problem in that the print layer may be separated as time passes even when external impact is not applied thereto.

In Patent Document 0001, Korean Patent Publication No. 10-1529888 (Date of Publication: Jul. 31, 2014), masking and chemical etching are performed on a primarily anodized aluminum surface, and then secondary anodizing is performed to implement a single color or composite color. However, there are problems in that adhesion of a masking layer to the aluminum material is significantly reduced, and when the masking layer is dipped in an etching solution, the masking layer is separated, which makes it impossible to perform etching at a depth that gives a stereoscopic effect.

### SUMMARY

A manufacturing method of an aluminum exterior panel according to one embodiment of the present invention may include: preparing an aluminum material; machining to shape an edge of the aluminum material; implementing a fine multilayered pattern on a surface of the machined aluminum material; forming fine corrugations on the surface of the aluminum material on which the pattern is implemented; anodizing to form pores on the surface of the aluminum material on which the fine corrugations are formed; digital printing of implementing a color and an image on the aluminum material on which the pores are formed; and sealing to close the pores.

Also, in the manufacturing method of an aluminum exterior panel according to one embodiment of the present invention, the implementing of the fine multilayered pattern may be performed using at least one of a laser machining and a chemical etching method.

Also, in the manufacturing method of an aluminum exterior panel according to one embodiment of the present invention, the laser machining may be performed 1 to 60 times with an output in a range of 30 W to 1,000 W.

Also, in the manufacturing method of an aluminum exterior panel according to one embodiment of the present invention, the chemical etching method may include: masking the surface of the aluminum material with a silk printing method using an asphalt-based ink; and after the masking, drying the surface of the aluminum material for 30 to 120 minutes at a temperature in a range of 90° C. to 110° C.

Also, in the manufacturing method of an aluminum exterior panel according to one embodiment of the present invention, the chemical etching method may include dipping the aluminum material for 5 to 15 minutes in a solution containing 5 wt % to 8 wt % of NaOH and having a temperature in a range of 40° C. to 60° C.

Also, in the manufacturing method of an aluminum exterior panel according to one embodiment of the present invention, the chemical etching method may include removing masking using a cyclohexanone or methyl isobutyl ketone (MIBK) solution.

Also, in the manufacturing method of an aluminum exterior panel according to one embodiment of the present invention, the forming of the fine corrugation may be performed using a chemical sanding method or a sand blasting method.

Also, in the manufacturing method of an aluminum exterior panel according to one embodiment of the present invention, the chemical sanding method may be performed by dipping the aluminum material for 10 to 60 seconds in a chemical sanding solution having a temperature in a range of 85° C. to 95° C., and the chemical sanding solution may contain, in vol %, 60 to 70% of phosphoric acid (H3PO4) and the remainder comprising sulfuric acid (H2SO4).

Also, in the manufacturing method of an aluminum exterior panel according to one embodiment of the present invention, the sand blasting method may be performed at a pressure of 3 to 6 bar with a polishing material having a diameter in a range of 30 μm to 300 μm.

Also, in the manufacturing method of an aluminum exterior panel according to one embodiment of the present invention, the polishing material may be at least one of stainless steel, ceramic, glass, and emery.

Also, an aluminum exterior panel according to one embodiment of the present invention may include: an aluminum material; an edge shaped on a corner of the aluminum material; a fine multilayered pattern on a surface of the aluminum material; pores formed on the surface of the aluminum material having the fine multilayered pattern; a digital printing layer on one surface or all surfaces of the aluminum material on which the pores are formed; and an aluminum oxide film on the digital printing layer.

Also, in the aluminum exterior panel according to one embodiment of the present invention, the aluminum material may have a thickness in a range of 0.5 mm to 5 mm.

Also, in the aluminum exterior panel according to one embodiment of the present invention, the edge shape may have a C-chamfering amount in a range of C0.3 to C5.0 or an R-chamfering amount in a range of R0.3 to R5.0.

Also, in the aluminum exterior panel according to one embodiment of the present invention, the fine multilayered pattern may have a depth in a range of 10 μm to 1,000 μm and a surface roughness Ra in a range of 10 μm to 50 μm.

Also, in the aluminum exterior panel according to one embodiment of the present invention, the aluminum oxide film may have a thickness in a range of 10 μm to 15 μm.

Also, a refrigerator according to one embodiment of the present invention may include: a main body; and a door configured to open or close the main body, at least one of the main body and the door may include an aluminum exterior panel, and the aluminum exterior panel may include an aluminum material, an edge shaped on a corner of the aluminum material, a fine multilayered pattern on a surface of the aluminum material, pores formed on the surface of the aluminum material having the fine multilayered pattern, a digital printing layer on one surface or all surfaces of the aluminum material on which the pores are formed, and an aluminum oxide film on the digital printing layer.

Also, in the refrigerator according to one embodiment of the present invention, the aluminum material may have a thickness in a range of 0.5 mm to 5 mm.

Also, in the refrigerator according to one embodiment of the present invention, the edge shape may have a C-chamfering amount in a range of C0.3 to C5.0 or an R-chamfering amount in a range of R0.3 to R5.0.

Also, in the refrigerator according to one embodiment of the present invention, the fine multilayered pattern may have a depth in a range of 10 μm to 1,000 μm and a surface roughness Ra in a range of 10 μm to 50 μm.

In addition, in the refrigerator according to one embodiment of the present invention, the aluminum oxide film may have a thickness in a range of 10 μm to 15 μm.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a flowchart of a manufacturing method of an aluminum exterior panel according to one example of the present invention.

FIG. 2 is a picture of an edge shape formed by C-chamfering during machining according to an embodiment of the disclosure.

FIG. 3 is a picture of an edge shape formed by R-chamfering during the machining according to an embodiment of the disclosure.

FIG. 4 is a picture of a fine multilayered pattern formed by laser machining during pattern implementing according to an embodiment of the disclosure.

FIG. 5 is a picture of a final product manufactured through the laser machining of FIG. 4 according to an embodiment of the disclosure.

FIG. 6 is a picture of smut generated during high-output laser machining according to an embodiment of the disclosure.

FIG. 7 is a picture of masking on a surface of an aluminum material for chemical etching thereof according to an embodiment of the disclosure.

FIG. 8 is a picture of a final product manufactured through the chemical etching of FIG. 7 according to an embodiment of the disclosure.

FIG. 9 is a picture of the surface of the aluminum material prior to sand blasting for formation of fine corrugations according to an embodiment of the disclosure.

FIG. 10 is a picture of the surface of the aluminum material after the sand blasting for the formation of the fine corrugations according to an embodiment of the disclosure.

FIG. 11 is a picture of pores on the surface, which are formed through anodizing, enlarged by a factor of 500,000 using a scanning electron microscope (SEM) according to an embodiment of the disclosure.

FIG. 12 is a picture of the surface of the aluminum material on which digital printing is performed that is enlarged by a factor of 200,000 using the SEM according to an embodiment of the disclosure.

FIG. 13 is a picture of the surface of the aluminum material on which pore sealing has not been performed that is enlarged by a factor of 200,000 using the SEM according to an embodiment of the disclosure.

FIG. 14 is a picture of the surface of the aluminum material on which pore sealing has been performed that is enlarged by a factor of 200,000 using the SEM according to an embodiment of the disclosure.

FIG. 15 shows pictures of results of a scratch resistance test conducted by scratching 304 stainless steel (STS) back and forth using a key according to an embodiment of the disclosure.

FIG. 16 shows pictures of results of a scratch resistance test conducted by scratching the aluminum exterior panel according to one example of the present invention back and forth using a key according to an embodiment of the disclosure.

FIG. 17 is a picture of a result of an external impact test on the 304STS according to an embodiment of the disclosure.

FIG. 18 is a picture of a result of an external impact test on the aluminum exterior panel according to one example of the present invention.

FIG. 19 is a perspective view of a refrigerator according to one embodiment of the present invention.

FIG. 20 is an exterior view of a dish washer according to one embodiment of the present invention.

FIG. 21 is an exterior view of a hood according to one embodiment of the present invention.

### DETAILED DESCRIPTION

Hereinafter, embodiments of the present invention will be described in detail with reference to the accompanying drawings. The following embodiments are presented to sufficiently convey the spirit of the present invention to those of ordinary skill in the art to which the present invention pertains. The present invention is not limited to the embodiments presented herein and may also be embodied in different forms. In the drawings, illustration of parts irrelevant to the description may be omitted to clarify the present invention, and sizes of components may be somewhat exaggerated to help understanding.

Throughout the specification, when a certain part is described as “including” a certain component, unless particularly described otherwise, this means that the part may further include other components instead of excluding other components.

A singular expression includes a plural expression unless the context clearly indicates otherwise.

A manufacturing method of an aluminum exterior panel according to one embodiment of the present invention may include: preparing an aluminum material; machining for implementing an edge shape of the aluminum material; pattern implementing of implementing a fine multilayered pattern on a surface of the processed aluminum material; fine corrugation forming of forming fine corrugations on the surface of the aluminum material on which the pattern is implemented; anodizing for forming pores on the surface of the aluminum material on which the fine corrugations are formed; digital printing of implementing a color and an image on the aluminum material on which the pores are formed; and pore sealing for closing the pores.

The present invention is directed to maximizing a metallic effect and a stereoscopic effect by performing at least one of laser machining and a chemical etching method.

The present invention is also directed to implementing various colors using digital printing and improving color deviation defects.

In addition, the present invention is directed to improving durability by a manufacturing method in which a digital printing layer is not exposed on an outermost surface.

According to one example of the present invention, a metallic effect and a stereoscopic effect can be maximized by performing at least one of laser machining and a chemical etching method.

Also, according to one example of the present invention, various colors can be implemented using digital printing and color deviation defects can be improved.

In addition, according to one embodiment of the present invention, durability can be improved by a manufacturing method in which a digital printing layer is not exposed on an outermost surface.

However, advantageous effects that can be achieved by an aluminum exterior panel and a manufacturing method thereof according to embodiments of the present invention are not limited to those mentioned above, and other unmentioned advantageous effects should be clearly understood by those of ordinary skill in the art to which the present invention pertains from the description below.

A manufacturing method of an aluminum exterior panel according to one embodiment of the present invention may include: preparing an aluminum material; machining for implementing an edge shape of the aluminum material; pattern implementing of implementing a fine multilayered pattern on a surface of the processed aluminum material; fine corrugation forming of forming fine corrugations on the surface of the aluminum material on which the pattern is implemented; anodizing for forming pores on the surface of the aluminum material on which the fine corrugations are formed; digital printing of implementing a color and an image on the aluminum material on which the pores are formed; and pore sealing for closing the pores.

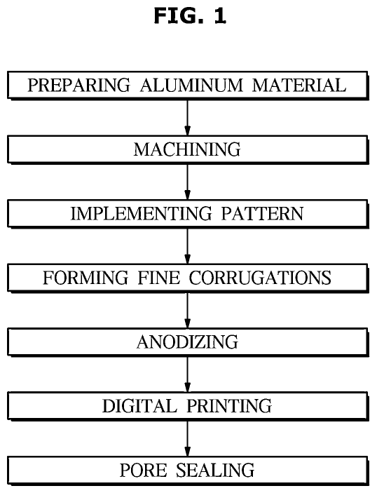

FIG. 1 is a flowchart of a manufacturing method of an aluminum exterior panel according to one example of the present invention.

Referring to FIG. 1, a manufacturing method of an aluminum exterior panel according to one embodiment of the present invention may include a series of preparing, machining, pattern implementing, fine corrugation forming, anodizing, digital printing, and pore sealing.

In the present invention, an anodizable aluminum alloy from a 1000 to 7000 series aluminum alloy may be prepared as an aluminum material. The aluminum material may have a thickness in a range of 0.8 mm to 5.0 mm. However, the present invention is not limited thereto, and the type and thickness of the aluminum material may be changed according to the purpose and shape.

In the manufacturing method of an aluminum exterior panel according to one embodiment of the present invention, the machining may be performed by computer numerical control (CNC) machining.

CNC machining is a method of machining a material through computer control using an NC machine tool having a small computer embedded therein. A CNC machining device may perform machining at a speed of 10,000 rpm to 50,000 rpm using a poly crystalline diamond (PCD) material. Generally, a CNC machining device performs machining at a speed of 10,000 rpm, but in the present invention, since machining is performed at a high speed of more than 10,000 rpm, productivity may be improved.

The machining may be performed prior to or after the pattern implementing.

In the manufacturing method of an aluminum exterior panel according to one embodiment of the present invention, the pattern implementing may be performed using at least one of laser machining and a chemical etching method.

Laser machining is a method in which a desired image is input to a laser machining device to implement a pattern having various depths on a surface of an aluminum material. The output, the number of operations, and the speed of laser machining may be adjusted for each position on a pattern to adjust depths. By implementing a pattern on a surface of an aluminum material, a natural metallic effect and stereoscopic effect may be maximized.

The laser machining may be performed 1 to 60 times with an output in a range of 30 W to 1,000 W. The number of times the laser machining is performed is reduced with an increase in the output of the laser machining, but since there is a problem in that smut is generated on a product surface when high-output laser machining is performed, it is necessary to appropriately control the output and the number of operations. The laser machining may be performed at a scan speed of 200 mm/s to 3,000 mm/s in a pulse type mode. Based on the output of 1,000 W, a pattern having a depth of 13 μm may be formed with each laser machining.

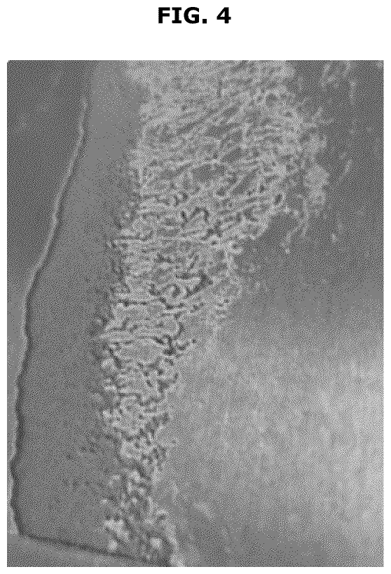

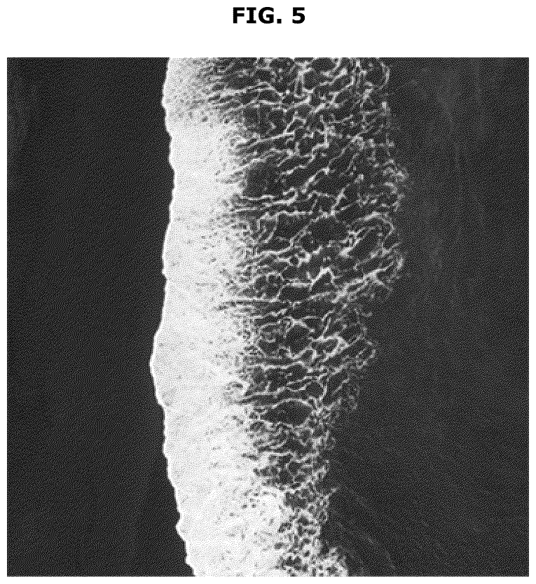

FIG. 4 is a picture of a fine multilayered pattern formed by laser machining during the pattern implementing, and FIG. 5 is a picture of a final product manufactured through the laser machining of FIG. 4.

Referring to FIGS. 4 and 5, it can be seen that a fine multilayered pattern of various depths is implemented on a surface of an aluminum material, and a final product in which a metallic effect and a stereoscopic effect are maximized is completed.

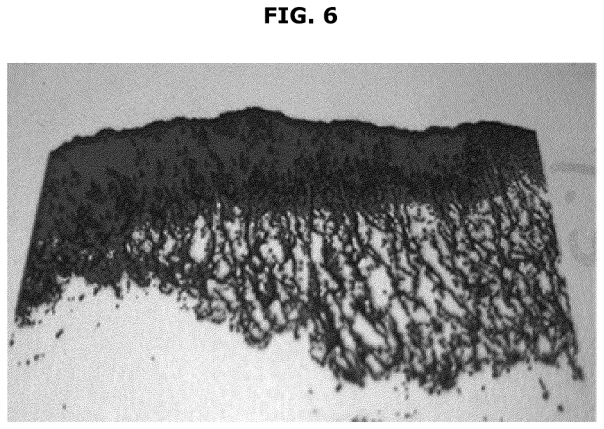

FIG. 6 is a picture of smut generated during high-output laser machining that is taken using an optical microscope.

Referring to FIG. 6, smut generated during high-output laser machining can be seen. In a case where laser machining is performed with a high output, smut that is oxidized due to high-temperature heat may be generated. When the smut is not removed, a dark color may develop on the final product or a film may be separated. Therefore, after the high-output laser machining, a cleaning task may be performed using low-output laser machining. Also, the cleaning task may be performed in the fine corrugation forming or anodizing which is a subsequent process.

The chemical etching method is a method of machining a surface of a material using a chemical.

According to one example of the present invention, the chemical etching method may include a series of masking, drying, dipping, and masking removing.

In the masking, an asphalt-based ink having excellent chemical resistance may be used to mask a surface of an aluminum material by silk printing.

After the masking, drying is performed for 30 to 120 minutes at a temperature in a range of 90° ° C. to 110° C. to perform high-temperature hardening of a masking layer, and thus adhesion to the surface of the aluminum material may be strengthened. In this way, the masking layer may be prevented from being separated even when the aluminum material is dipped for 20 minutes or more in a strong alkaline etching solution. However, the masking layer may break in a case where a drying temperature is high or a drying time is long.

Next, an operation in which the aluminum material is dipped for 5 to 15 minutes in a solution containing 5 wt % to 8 wt % of NaOH and having a temperature in a range of 40° C. to 60° ° C. may be performed. A surfactant may be added as necessary. Here, a fine multilayered pattern may be formed as unmasked portions are etched. The depth of the formed multilayered pattern may increase with an increase in the time for which dipping is performed.

After the fine multilayered pattern is implemented, masking may be removed using a cyclohexanone or methyl isobutyl ketone (MIBK) solution. The aluminum material may be dipped in an ultrasonic bath or rubbed with a soft cloth to effectively remove the masking.

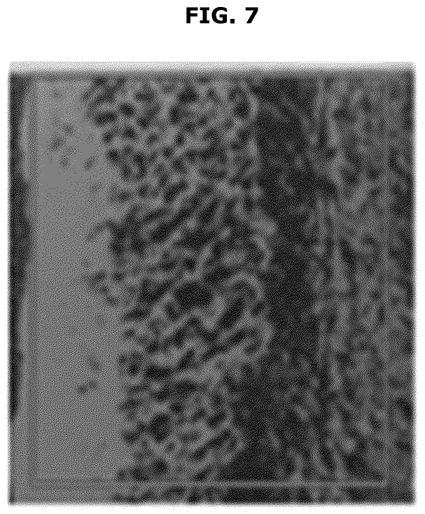

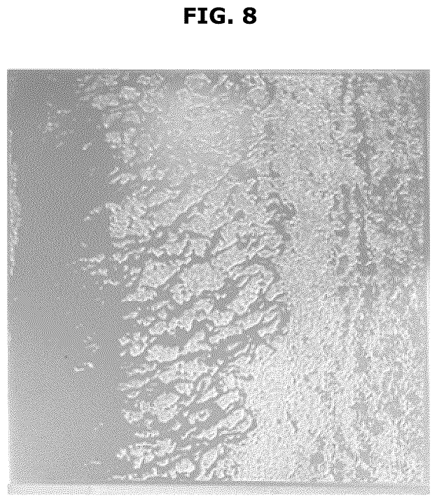

FIG. 7 is a picture of the masking on the surface of the aluminum material for chemical etching thereof, and FIG. 8 is a picture of the final product manufactured through the chemical etching of FIG. 7.

Referring to FIGS. 7 and 8, it can be seen that the fine multilayered pattern is formed as the unmasked portions are etched, and the final product in which a metallic effect and a stereoscopic effect are maximized is completed.

Meanwhile, in order to implement an effective fine multilayered pattern, the laser machining and the chemical etching method may be performed in combination. As an example, laser machining may be primarily performed to implement a deep fine multilayered pattern, and then partial chemical etching may be secondarily performed. Also, in order to implement a specific pattern or image, chemical etching may be performed first, and then laser machining may be performed.

In the manufacturing method of an aluminum exterior panel according to one embodiment of the present invention, the fine corrugation forming may be performed using a chemical sanding method or a sand blasting method. By forming fine corrugations on the surface of the aluminum material, the metallic effect may be further enhanced.

The chemical sanding method may be performed by electroless dipping of the aluminum material for 10 to 60 seconds in a chemical sanding solution having a temperature in a range of 85° C. to 95° C. The chemical sanding solution may contain, in vol %, 60 to 70% of phosphoric acid (H3PO4) and the remainder comprising sulfuric acid (H2SO4). Both phosphoric acid (H3PO4) and sulfuric acid (H2SO4) may serve to polish the corrugations on the surface of the aluminum material. Phosphoric acid (H3PO4) may serve to polish large corrugations, and sulfuric acid (H2SO4) may serve to polish small corrugations.

The sand blasting method may be performed at a pressure of 3 to 6 bar with a polishing material having a diameter in a range of 30 μm to 300 μm. A material of the polishing material may be at least one of stainless steel, ceramic, glass, and emery. The stainless steel, ceramic, and glass in the form of spherical particles may be used, and the emery may have a needle shape. However, in consideration of roughness of the surface of the aluminum material, it may be preferable to use spherical glass particles. However, the present invention is not limited thereto.

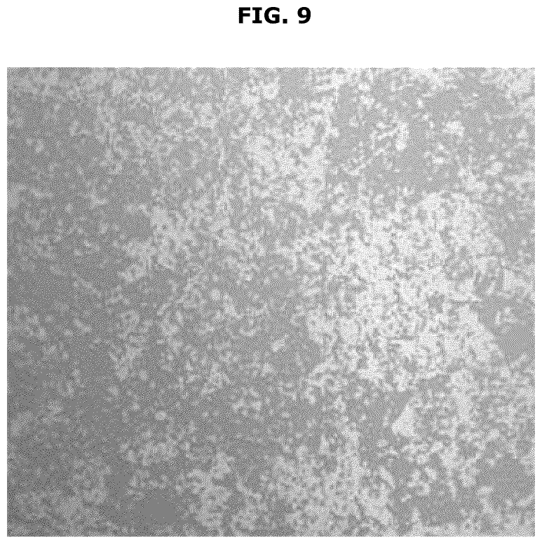

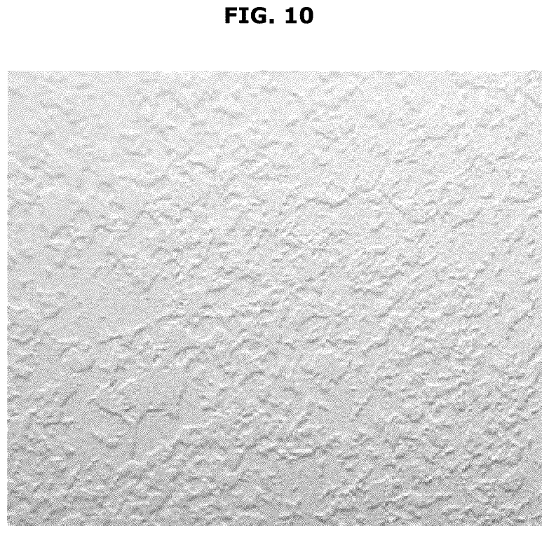

FIG. 9 is a picture of the surface of the aluminum material prior to the sand blasting for the formation of the fine corrugations, and FIG. 10 is a picture of the surface of the aluminum material after the sand blasting for the formation of the fine corrugations.

Referring to FIGS. 9 and 10, it can be seen that the metallic effect is further enhanced by forming fine corrugations on the surface of the aluminum material through sand blasting.

Next, the anodizing for forming pores on the surface of the aluminum material on which the fine corrugations are formed may be performed. By forming fine pores on the surface of the aluminum material through anodizing, adhesion of a digital printing layer may be improved, and scratch resistance and dent resistance of the final product may be improved.

The anodizing may be performed by applying a voltage in a range of 12 V to 17 V using a solution containing 18 wt % to 22 wt % of sulfuric acid (H2SO4) at a temperature in a range of 18° ° C. to 23° C. Here, preferably, the anodizing may be performed under a condition in which the amount of dissolved aluminum is in a range of 5 g/L to 15 g/L.

After the anodizing, moisture on the surface of the aluminum material may be removed prior to the digital printing. To this end, natural drying may be performed at room temperature, or drying may be performed for 1 to 10 minutes with hot air having a temperature in a range of 60° C. to 80° C.

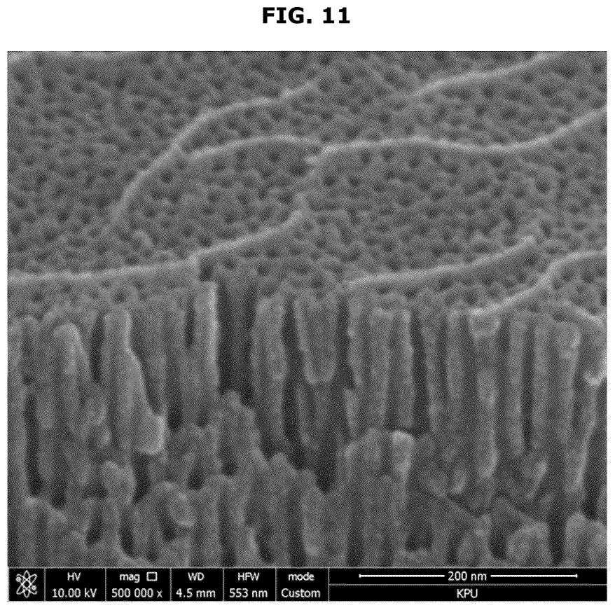

FIG. 11 is a picture of the pores on the surface, which are formed through the anodizing, enlarged by a factor of 500,000 using a scanning electron microscope (SEM). Referring to FIG. 11, it can be seen that a plurality of fine pores are formed on the surface of the aluminum material by performing the anodizing.

The digital printing may be performed to implement a color and an image on the aluminum material on which the fine pores are formed. The digital printing may be performed using at least one of a thermosetting type ink and a natural hardening type ink. The digital printing layer may be formed in the fine pores.

An interval between a digital printing head and the surface of the aluminum material may be in a range of 1 mm to 3 mm so that printing is uniformly performed on an edge machining surface.

Meanwhile, while anodizing coloring technology, which is a universal technology for implementing a color, allows a color and an image to be implemented on all surfaces of an aluminum material, in the present invention, digital printing is performed so that a color and an image may be implemented only on one surface of an aluminum material instead of all surfaces of the aluminum material.

Also, while color deviations between unit production lots occur because the amount of ink adsorbed onto an aluminum material is different for each ink mixture in the anodizing coloring technology, in the present invention, digital printing is performed so that ink is automatically controlled and sprayed with a program, and thus color deviations between unit production lots are reduced. That is, by performing the digital printing, color stability may be improved.

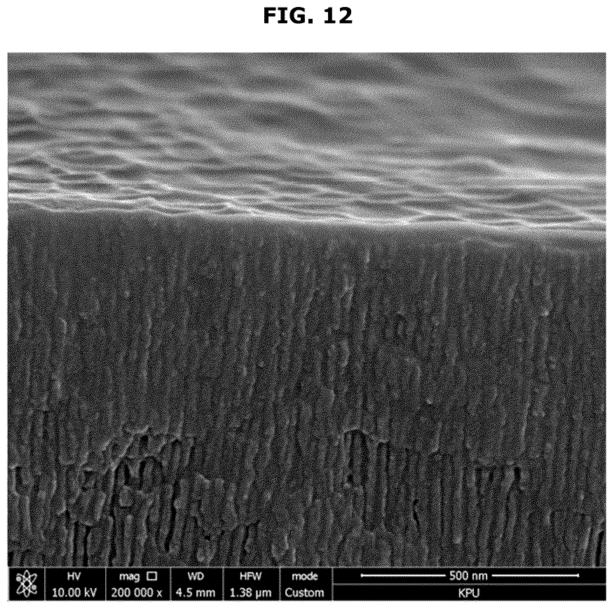

FIG. 12 is a picture of the surface of the aluminum material on which digital printing is performed that is enlarged by a factor of 200,000 using the SEM. Referring to FIG. 12, it can be seen that the digital printing layer is formed in the fine pores of the surface of the aluminum material.

Next, the pore sealing may be performed to close the fine pores. By performing the pore sealing to form an aluminum oxide (Al2O3) film on the surface of the aluminum material, durability may be maximized to prevent the digital printing layer in the pores from being separated, decolored, discolored, or the like. Also, by a dense film being formed on the outermost layer of the product, ease of cleaning the product may be improved.

The pore sealing may be performed by dipping the aluminum material for 10 to 30 minutes in a solution containing 3 wt % to 4 wt % of nickel acetate (Ni(CHCOO)2) at a temperature in a range of 80° C. to 90° C.

In a case where the concentration of the Ni(CHCOO)2 solution is low or the time for which the pore sealing is performed is short, the fine pores may not be sufficiently closed, and the durability improving effect may be reduced. However, in a case where the concentration of the Ni(CHCOO)2 solution is too high or the time for which the pore sealing is performed is long, white powder may be formed on the surface of the aluminum material, and a separate washing process may be added.

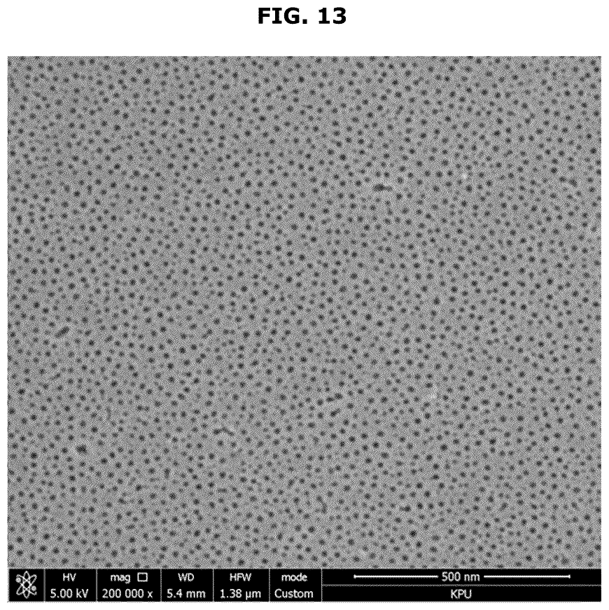

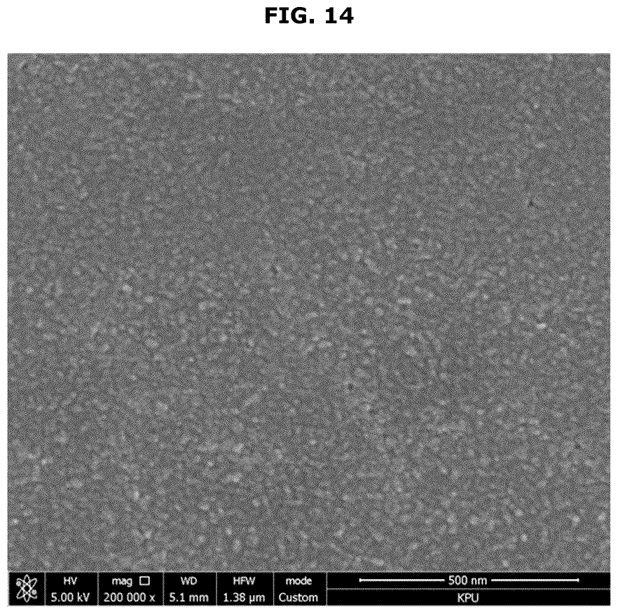

FIG. 13 is a picture of the surface of the aluminum material on which pore sealing has not been performed that is enlarged by a factor of 200,000 using the SEM, and FIG. 14 is a picture of the surface of the aluminum material on which pore sealing has been performed that is enlarged by a factor of 200,000 using the SEM.

Referring to FIGS. 13 and 14, it can be seen that, while the pores are not closed on the surface of the aluminum material on which pore sealing has not been performed, a dense aluminum oxide film is formed on the surface of the aluminum material on which pore sealing has been performed.

Next, an aluminum exterior panel according to another aspect of the present invention will be described.

An aluminum exterior panel according to one embodiment of the present invention may include: an aluminum material; an edge shape formed on a corner of the aluminum material; a fine multilayered pattern provided on a surface of the aluminum material; pores formed on the surface of the aluminum material on which the fine multilayered pattern is provided; a digital printing layer provided on one surface or all surfaces of the aluminum material on which the pores are formed; and an aluminum oxide film provided on the digital printing layer.

The aluminum material may have a thickness in a range of 0.5 mm to 5 mm. However, the present invention is not limited thereto, and the aluminum material may have various other thicknesses according to the purpose.

The edge shape formed on the corner of the aluminum material may have a C-chamfering amount in a range of C0.3 to C5.0 or an R-chamfering amount in a range of R0.3 to R5.0. Here, C0.3 to C5.0 or R0.3 to R5.0 indicates the degree to which the edge shape is rounded.

By the edge shape being provided on the corner of the aluminum material by C-chamfering or R-chamfering, the corner may be prevented from being dented, and a high-quality aesthetic sense maybe secured.

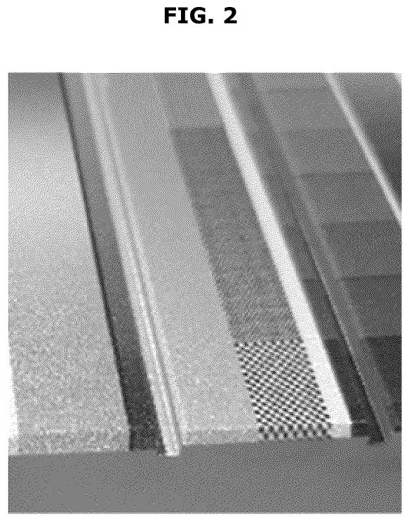

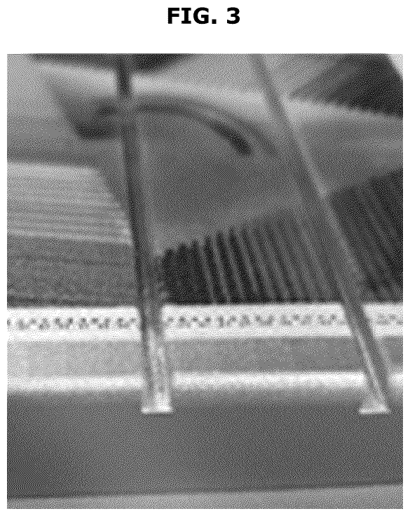

FIG. 2 is a picture of an edge shape formed by C-chamfering during the machining, and FIG. 3 is a picture of an edge shape formed by R-chamfering during the machining. Referring to FIGS. 2 and 3, it can be seen that an edge shape is provided on the corner of the aluminum material by C-chamfering or R-chamfering.

A fine multilayered pattern may be formed on the surface of the aluminum material. The fine multilayered pattern may have a depth in a range of 10 μm to 1,000 μm and a surface roughness Ra in a range of 10 μm to 50 μm.

In a case where the depth of the fine multilayered pattern is shallow, or the surface roughness thereof is low, the fine multilayered pattern may not be felt by touch. However, in a case where the depth of the fine multilayered pattern is too deep, or the surface roughness thereof is high, productivity may be reduced, and the pattern may not be distinct, and thus a desired image may not be secured.

Fine pores may be formed on the surface of the aluminum material on which the fine multilayered pattern is provided, and a digital printing layer may be formed in the fine pores. As described above, in the present invention, by performing digital printing, a color and an image may be implemented only on one surface of the aluminum material instead of all surfaces of the aluminum material. Also, a digital printing layer may also be formed on the edge shape formed on the corner of the aluminum material.

An aluminum oxide film may be provided on the digital printing layer. The aluminum oxide film may have a thickness in a range of 10 μm to 15 μm. When the thickness of the aluminum oxide film is thin, it is difficult to obtain a durability improving effect. However, when the thickness of the aluminum oxide film is too thick, productivity may be reduced.

Next, a refrigerator according to another aspect of the present invention will be described.

A refrigerator according to one embodiment of the present invention may include: a main body; and a door configured to open or close the main body, at least one of the main body and the door may include an aluminum exterior panel, and the aluminum exterior panel may include an aluminum material, an edge shape formed on a corner of the aluminum material, a fine multilayered pattern provided on a surface of the aluminum material, pores formed on the surface of the aluminum material on which the fine multilayered pattern is provided, a digital printing layer provided on one surface or all surfaces of the aluminum material on which the pores are formed, and an aluminum oxide film provided on the digital printing layer.

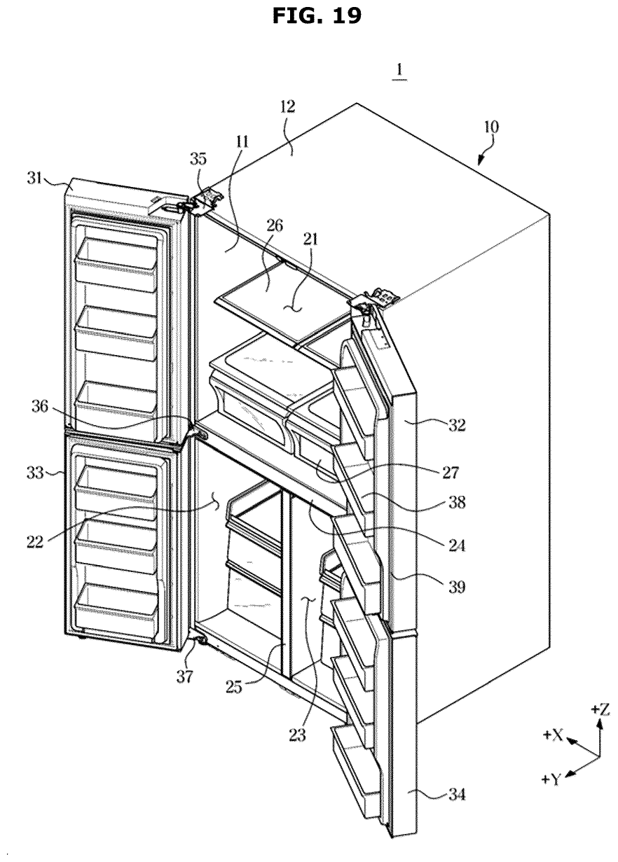

FIG. 19 is a perspective view of the refrigerator according to one embodiment.

In embodiments described below, directions defined by the X-axis, Y-axis, and Z-axis are based on a home appliance, and thus a width direction of the home appliance is defined as the X-axis direction, a depth direction of the home appliance is defined as the Y-axis direction, and a height direction of the home appliance is defined as the Z-axis direction.

FIG. 19 illustrates an exterior of a refrigerator 1 according to one embodiment of the present invention. The home appliance according to one embodiment of the present invention may include an exterior provided using an aluminum exterior panel.

Referring to FIG. 19, the refrigerator 1 may include a main body 10, storage compartments 21, 22, and 23 formed inside the main body 10, doors 31, 32, 33, and 34 configured to open or close the storage compartments 21, 22, and 23, and a cold air supply device (not illustrated) configured to supply cold air to the storage compartments 21, 22, and 23.

The main body 10 may include a cavity 11 forming the storage compartments 21, 22, and 23, a cabinet 12 coupled to an outer side of the cavity 11 to form the exterior, and an insulator (not illustrated) provided between the cavity 11 and the cabinet 12 to insulate the storage compartments 21, 22, and 23.

The storage compartments 21, 22, and 23 may be divided by a horizontal partition 24 and a vertical partition 25. The storage compartments 21, 22, and 23 may be divided into an upper storage compartment 21 and lower storage compartments 22 and 23 by the horizontal partition 24, and the lower storage compartments 22 and 23 may be divided into a left lower storage compartment 22 and a right lower storage compartment 23 by the vertical partition 25.

The upper storage compartment 21 may be used as a refrigerating compartment, and the lower storage compartments 22 and 23 may be used as freezing compartments. However, the above-described division and purposes of the storage compartments 21, 22, and 23 are only one example, and the present invention is not limited thereto.

A shelf 26 on which food is placed and a storage container 27 configured to store food may be provided inside the storage compartments 21, 22, and 23.

The cold air supply device may generate cold air using a cooling circulation cycle in which a refrigerant is compressed, condensed, expanded, and evaporated and may supply the generated cold air to the storage compartments 21, 22, and 23.

The storage compartment 21 may be opened or closed by the pair of doors 31 and 32. The doors 31 and 32 may be rotatably coupled to the main body 10. The storage compartment 22 may be opened or closed by the door 33, and the door 33 may be rotatably coupled to the main body 10. The storage compartment 23 may be opened or closed by the door 34, and the door 34 may be rotatably coupled to the main body 10. Hinges 35, 36, and 37 may be provided in the main body 10 to rotatably couple the doors 31, 32, 33, and 34 to the main body 10.

A door guard 38 configured to store food and a door gasket 39 configured to come in close contact with a front surface of the main body 10 to seal the storage compartments 21, 22, and 23 may be provided on back surfaces of the doors 31, 32, 33, and 34.

An aluminum exterior panel may be provided on at least one portion of the cabinet 12 of the main body 10. Since the aluminum exterior panel is the same as the aluminum exterior panel described above, detailed description thereof will be omitted.

Also, an aluminum exterior panel may be provided on the exterior of the doors 31, 32, 33, and 34. Since the aluminum exterior panel is the same as the aluminum exterior panel described above, description thereof will be omitted.

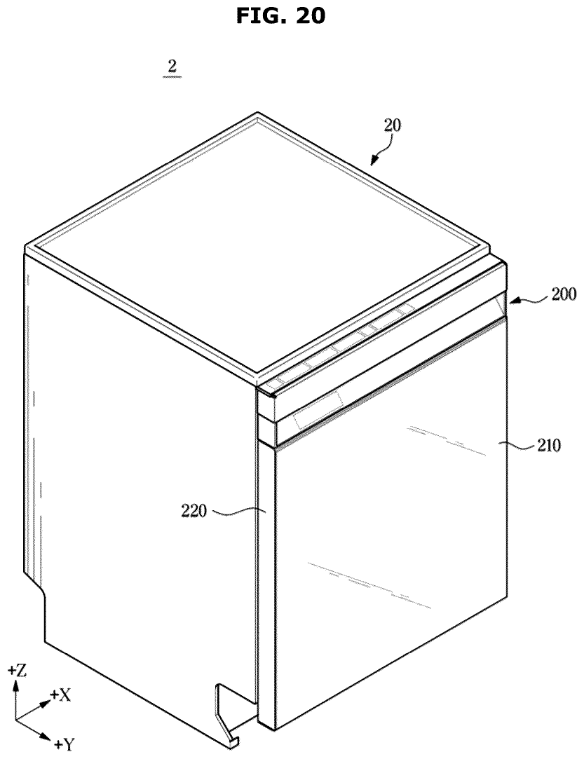

FIG. 20 is an exterior view of a dish washer according to one embodiment.

Referring to FIG. 20, a dish washer 2 may include a main body 20 forming an exterior and a door 200 rotatably coupled to the main body 20.

A washing compartment (not illustrated) configured to accommodate dishes may be provided inside the main body 20. The dish washer 2 may include various components such as a plurality of nozzles configured to wash the dishes accommodated in the washing compartment, a driving device configured to drive the plurality of nozzles, and a controller configured to control the driving device. The door 200 may open or close the washing compartment provided inside the main body 20.

The door 200 may include a door panel 210 and a door body 220, and the door panel 210 may be detachably coupled to the door body 220. As illustrated in FIG. 20, the door panel 210 may be provided on a front surface of the door 200, and the door body 220 may be provided on a rear surface of the door 200. The front surface of the door 200 may be a surface visible to a user in a state in which the door 200 is closed, and the rear surface of the door 200 may be a surface toward the inside of the main body 20 in the state in which the door 200 is closed.

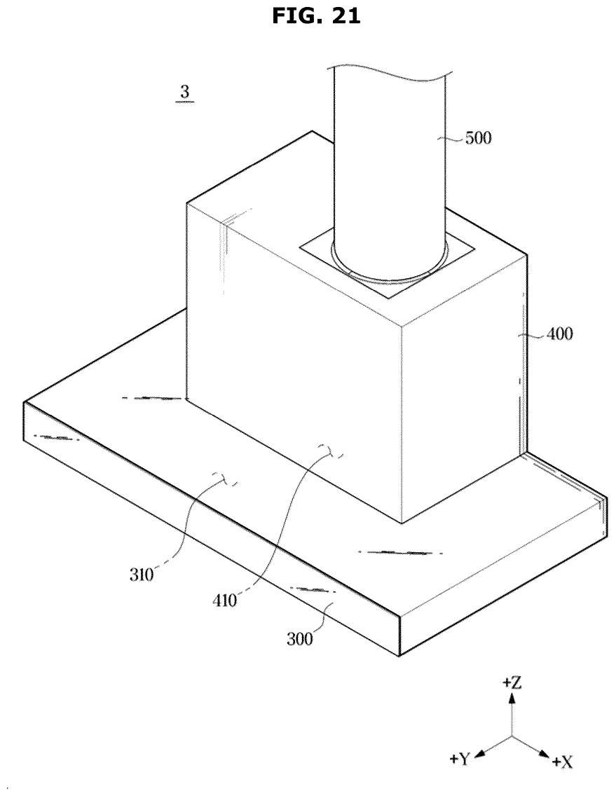

FIG. 21 is an exterior view of a hood according to one embodiment.

Referring to FIG. 21, a hood 3 according to one embodiment of the present invention may include a main body, which includes a first case 300 and a second case 400, and a fan module (not illustrated).

The first case 300 may include an inlet into which smoke or the like generated from a heating device is introduced. The inlet may be provided on a lower surface of the first case 300. A filter corresponding to the inlet may be mounted on the inlet. The filter may be mounted on the first case 300 to cover the inlet. The filter may be provided to filter foreign matter contained in the smoke or the like introduced into the inlet.

The first case 300 may be provided in a substantially rectangular parallelepiped shape. A flow path 310 may be formed inside the first case 300. The flow path 310 may be provided to guide air, which has passed through the filter and the inlet, to the second case 400. The flow path 310 may indicate a space inside the first case 300, or alternatively may indicate a space separately partitioned inside the first case 300 or a duct installed inside the first case 300.

The second case 400 may be disposed above the first case 300. The fan module may be disposed inside the second case 400. Like the first case 300, the second case 400 may be provided in a substantially rectangular parallelepiped shape. The second case 400 may be provided to have areas of a lower surface and an upper surface smaller than those of the first case 300 and a height greater than that of the first case 300. The second case 400 may be provided separately from the first case 300 and coupled thereto, or alternatively, the second case 400 and the first case 300 may be integrally provided. Also, the second case 400 may be provided by an upper surface of the first case 300 extending upward to be inclined relative to a first direction (Z-axis direction), and in this way, the second case 400 and the first case 300 may be integrally formed.

A flow path 410 may be formed inside the second case 400. The flow path 410 may be connected to the flow path 310 of the first case 300. Air introduced through the inlet may be discharged to the outside through an exhaust pipe 500 via the flow path 310 of the first case 300 and the flow path 410 of the second case 400. The fan module may be provided inside the flow path 410. The flow path 410 may outline a space inside the second case 400, or alternatively may outline a space separately partitioned inside the second case 400 or a duct installed inside the second case 400.

All of the home appliances 1, 2, and 3 according to the above-described examples include a panel forming the exterior of the main body 10, 20, 300, or 400. The aluminum exterior panel according to one example of the present invention may be used in other home appliances without particular limitations as long as the aluminum exterior panel may form an exterior of the home appliance and may be disposed at a position visible to a user.

Also, the aluminum exterior panel is not necessarily used as the panel of the main body 10, 20, 300, or 400. The home appliances 1 and 2 including the doors 31, 32, 33, and 34 or the door 200 used to open and close the space inside the main body 10 or the space inside the main body 20 include door panels forming the exterior of the doors 31, 32, 33, and 34 or a door panel forming the exterior of the door 200. That is, the door panels are visible to a user in a state in which the doors 31, 32, 33, 34, and 200 are closed. The doors 31, 32, 33, 34, and 200 are closed when the home appliances 1 and 2 are not in use, and in order to use the home appliances 1 and 2, the user has to approach and open the doors 31, 32, 33, 34, and 200.

Panels of the main bodies 10, 20, 300 and 400 and/or door panels 110, 210, 310, and 410 may be seen as components that have a great influence on aesthetic satisfaction of a user, durability, and usability.

In order to improve aesthetic satisfaction of the user without affecting functional performance of the main bodies 10, 20, 300, and 400 and/or the doors 31, 32, 33, 34, and 200, an image or a pattern may be implemented on the main body panels and/or door panels. Therefore, a metallic effect and a stereoscopic effect of the panels may be maximized, and the aesthetic satisfaction of the user with the home appliances 1, 2, and 3 may be improved.

Also, an example of a factor that may improve the durability of the main bodies 10, 20, 300, and 400 and/or the doors 31, 32, 33, 34, and 200 may be surface hardness of the main body panels and/or door panels. When the surface hardness of the panel is increased, resistance to everyday scratches or dents that may be formed in a user environment may be improved for the exterior of the home appliances 1, 2, and 3.

Further, for various contamination conditions that may occur in the user environment, when it is easy to remove contaminants on the main body panels and/or door panels, ease of cleaning the main bodies 10, 20, 300, and 400 and/or the doors 31, 32, 33, 34, and 200 may be improved.

To this end, the above-described aluminum exterior panel according to one example of the present invention may be used as the main body panels and/or door panels of the home appliances 1, 2, and 3.

Meanwhile, the above-described home appliances are only some examples of the home appliance according to one embodiment. Therefore, home appliances other than those described above may be included in an embodiment of the present invention as long as the home appliances include the above-described aluminum exterior panel.

Hereinafter, examples and comparative examples will be described to help understanding of the present invention. However, the following description only corresponds to one example relating to the content and advantageous effects of the present invention, and the scope of rights and the advantageous effects of the present invention are not necessarily limited thereto.

### EXAMPLES

### <Laser Machining Test>

Table 1 below shows changes in depths of a fine multilayered pattern according to the number of times laser machining was performed at a scan speed of 1,000 mm/s in a pulse type mode.

TABLE 1

| | | Number of times | | |
|---|---|---|---|---|
| | | laser machining is performed | | |
| | | 10 | 20 | 30 |
| Depth of fine | Maximum | 193.5 | 402.7 | 525.1 |
| multilayered | depth | | | |
| pattern (μm) | Minimum | 75.2 | 91.2 | 105.6 |
| | depth | | | |
| | Average | 130.1 | 320.0 | 457.0 |
| | depth | | | |

Referring to Table 1, it can be seen that the depth of the fine multilayered pattern increased with an increase in the number of times laser machining is performed. Also, it can be seen that a pattern having a depth of about 13 μm was formed with each laser machining.

### <Color Stability Test>

Table 2 below shows color deviations (ΔE) of aluminum exterior panel samples on which digital printing was performed produced according to one example of the present invention, which are examples, and aluminum exterior panel samples on which dip-type coloring was performed produced according to a typical anodizing technique, which are comparative examples. The color deviations were measured based on the CIE L*a*b* color system using a spectrophotometer. Here, ΔE indicates color deviation from a reference sample.

TABLE 2

| | L* | a* | b* | ΔE |
|---|---|---|---|---|
| Reference | 47.76 | −6.90 | −5.17 | — |
| sample of | | | | |
| Examples | | | | |
| Example 1 | 47.48 | −7.29 | −5.00 | 0.51 |
| Example 2 | 47.63 | −7.02 | −5.02 | 0.23 |
| Example 3 | 48.05 | −7.25 | −5.19 | 0.45 |
| Example 4 | 47.35 | −6.99 | −5.22 | 0.42 |
| Example 5 | 47.95 | −6.76 | −4.83 | 0.41 |
| Reference | 51.23 | −11.46 | −5.99 | — |
| sample of | | | | |
| Comparative | | | | |
| Examples | | | | |
| Comparative | 50.73 | −11.10 | −5.50 | 0.76 |
| Example 1 | | | | |
| Comparative | 50.61 | −11.45 | −5.17 | 1.03 |
| Example 2 | | | | |
| Comparative | 50.29 | −11.10 | −5.90 | 1.01 |
| Example 3 | | | | |
| Comparative | 50.45 | −11.16 | −5.85 | 0.85 |
| Example 4 | | | | |
| Comparative | 50.36 | −10.91 | −5.92 | 1.03 |
| Example 5 | | | | |

Referring to Table 2, in Examples 1 to 5 which are the aluminum exterior panels on which digital printing was performed produced according to one example of the present invention, the color deviations (ΔE) were shown to be low and in a range of 0.23 to 0.51. That is, color stability was excellent in all of Examples 1 to 5.

However, in Comparative Examples 1 to 5 which are the aluminum exterior panels on which dip-type coloring was performed produced according to the typical anodizing technique, the color deviations (ΔE) were shown to be relatively high and in a range of 0.76 to 1.03. That is, color stability was inferior in all of Comparative Examples 1 to 5.

### <Durability Test>

As durability tests, a scratch resistance test performed by scratching back and forth using a key and an external impact test were performed.

The scratch resistance test performed by scratching back and forth using a key was performed by scratching a surface of a sample back and forth 5 times, 10 times, and 20 times using a key and observing whether scratches formed.

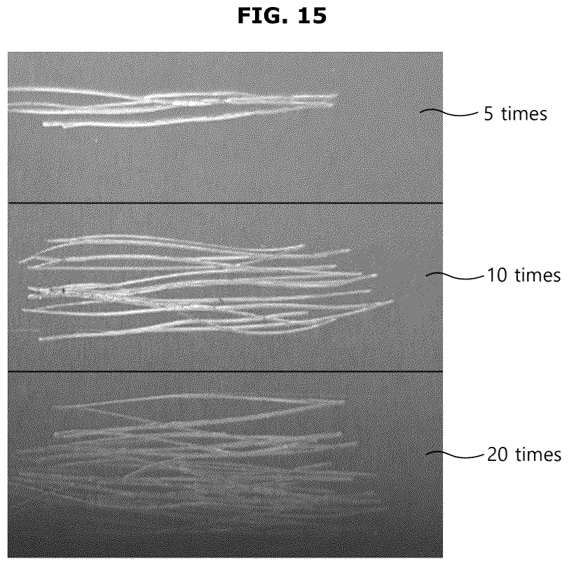

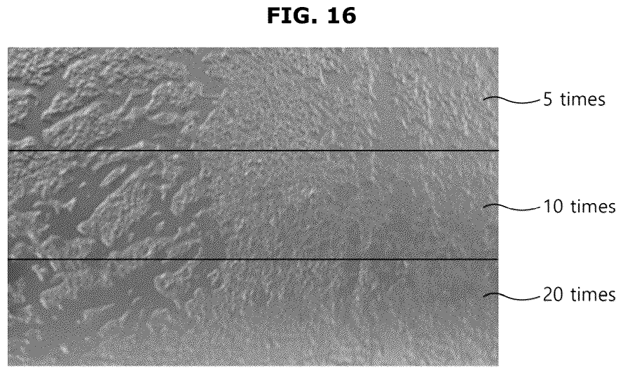

FIG. 15 shows pictures of results of a scratch resistance test conducted by scratching 304 stainless steel (STS) back and forth using a key, and FIG. 16 shows pictures of results of a scratch resistance test conducted by scratching the aluminum exterior panel according to one example of the present invention back and forth using a key.

Referring to FIGS. 15 and 16, surface scratches were clearly shown on the aluminum material on which pore sealing was not performed, but surface scratches were not visible to the naked eye on the aluminum material on which pore sealing was performed.

The external impact test was performed by causing a steel ball of 198.4 g to freely fall from a height of 30 cm onto a surface of a sample and observing whether a dent formed.

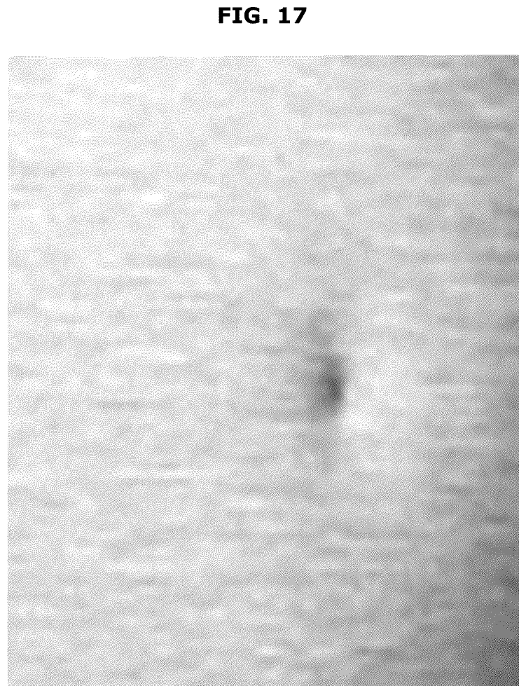

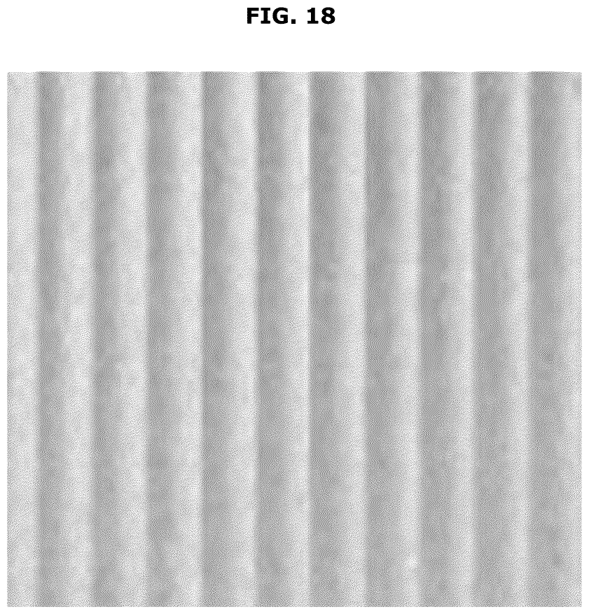

FIG. 17 is a picture of a result of an external impact test on the 304STS, and FIG. 18 is a picture of a result of an external impact test on the aluminum exterior panel according to one example of the present invention.

Referring to FIGS. 17 and 18, a surface dent was clearly formed on the 304STS, but a surface dent was not visible to the naked eye on the aluminum exterior panel according to one example of the present invention.

That is, durability of the aluminum exterior panel according to one example of the present invention was confirmed to be excellent.

### INDUSTRIAL APPLICABILITY

According to one example of the present invention, a metallic effect and a stereoscopic effect can be maximized by performing at least one of laser machining and a chemical etching method.

Also, according to one example of the present invention, various colors can be implemented using digital printing and color deviation defects can be improved.

In addition, according to one example of the present invention, durability can be improved by a manufacturing method in which a digital printing layer is not exposed on an outermost surface.

What is claimed is:

1. A manufacturing method of an aluminum exterior panel, the manufacturing method comprising:
preparing an aluminum material;
machining to shape an edge of the aluminum material;
implementing a fine multilayered pattern on a surface of the aluminum material;
forming fine corrugations on the surface of the aluminum material on which the fine multilayered pattern is implemented;
anodizing to form pores on the surface of the aluminum material on which the fine corrugations are formed;
digital printing of implementing a color and an image on the aluminum material on which the pores are formed; and
sealing to close the pores.

2. The manufacturing method of claim 1, wherein the implementing of the fine multilayered pattern is performed using at least one of a laser machining and a chemical etching method.

3. The manufacturing method of claim 2, wherein the laser machining is performed 1 to 60 times with an output in a range of 30 W to 1,000 W.

4. The manufacturing method of claim 2, wherein the chemical etching method includes:
masking the surface of the aluminum material with a silk printing method using an asphalt-based ink; and
after the masking, drying the surface of the aluminum material for 30 to 120 minutes at a temperature in a range of 90° C. to 110° C.

5. The manufacturing method of claim 2, wherein the chemical etching method includes dipping the aluminum material for 5 to 15 minutes in a solution containing 5 wt % to 8 wt % of NaOH and having a temperature in a range of 40° C. to 60° C.

6. The manufacturing method of claim 2, wherein the chemical etching method includes removing masking using a cyclohexanone or methyl isobutyl ketone (MIBK) solution.

7. The manufacturing method of claim 1, wherein the forming of the fine corrugation is performed using a chemical sanding method or a sand blasting method.

8. The manufacturing method of claim 7, wherein:
the chemical sanding method is performed by dipping the aluminum material for 10 to 60 seconds in a chemical sanding solution having a temperature in a range of 85° C. to 95° C.; and
the chemical sanding solution contains, in vol %, 60 to 70% of phosphoric acid (H₃PO₄) and a remainder comprising sulfuric acid (H₂SO₄).

9. The manufacturing method of claim 7, wherein the sand blasting method is performed at a pressure of 3 to 6 bar with a polishing material having a diameter in a range of 30 μm to 300 μm.

10. The manufacturing method of claim 9, wherein the polishing material is at least one of stainless steel, ceramic, glass, and emery.

11. An aluminum exterior panel comprising:
an aluminum material;
an edge shaped on a corner of the aluminum material;
a fine multilayered pattern on a surface of the aluminum material;
pores formed on the surface of the aluminum material having the fine multilayered pattern;
a digital printing layer on one surface or all surfaces of the aluminum material on which the pores are formed; and
an aluminum oxide film on the digital printing layer.

12. A refrigerator comprising:
a main body; and
a door configured to open or close the main body,
wherein at least one of the main body and the door includes an aluminum exterior panel, and
the aluminum exterior panel includes:
an aluminum material, an edge shaped on a corner of the aluminum material,
a fine multilayered pattern on a surface of the aluminum material,
pores formed on the surface of the aluminum material having the fine multilayered pattern,
a digital printing layer on one surface or all surfaces of the aluminum material on which the pores are formed, and
an aluminum oxide film on the digital printing layer.

13. The refrigerator of claim 12, wherein the aluminum material has a thickness in a range of 0.5 mm to 5 mm.

14. The refrigerator of claim 12, wherein the fine multilayered pattern has a depth in a range of 10 μm to 1,000 μm and a surface roughness Ra in a range of 10 μm to 50 μm.

15. The refrigerator of claim 12, wherein the aluminum oxide film has a thickness in a range of 10 μm to 15 μm.
